(19) United States
(12) Patent Application Publication
(10) Pub. No.: US 2014/0041964 A1
(43) Pub. Date: Feb. 13, 2014

(54) FOLDABLE ACCESS STAIRWAY FOR MACHINE

(71) Applicant: Joshua C. Bedyk, Sandwich, IL (US)

(72) Inventor: Joshua C. Bedyk, Sandwich, IL (US)

(73) Assignee: Caterpillar Inc., Peoria, IL (US)

(21) Appl. No.: 13/572,797

(22) Filed: Aug. 13, 2012

(51) Int. Cl. E06C 1/39; E06C 7/18

(52) U.S. Cl. 182/106

(57) ABSTRACT

An access stairway attached with a platform of a machine, which is movable between a lowered position and a folded position. The access stairway includes a stairway pivotally supported at the platform, and a handrail attached to the stairway. The handrail is configured to collapse and align substantially close to the stairway in the folded position to allow an operator movement onto the platform.

### TECHNICAL FIELD

The present disclosure relates to an access stairway provided with a platform of a machine, and more particularly to a foldable powered access ladder for providing access onto the platform of the machine.

### BACKGROUND

An access system for a machine, for example, a stairway, is used to reach different machine components within a reach of a platform of the machine for performing service or maintenance operations. For example, U.S. Pat. No. 8,074,768 discloses an access ladder configurable from an extended position for providing access to a structure and a stowed position. The access ladder comprises an elongated first member having a first step extending laterally therefrom. An elongated second member is associated with the first member and configured for translational movement relative thereto and has a second step extending laterally therefrom. A link extends between the second member and the structure such that rotation of the first member moves the second member translationally relative to the first member, thereby moving said at least one second step towards said at least one first step. However, there is still room for improvement in the art.

### SUMMARY

In one aspect, the present disclosure describes an access stairway attached with a platform and configured to move in a plane substantially perpendicular to the platform between a lowered position and a folded position. The access stairway includes a stairway configured to be pivotally supported at the platform, and a handrail attached to the stairway. The handrail is configured to collapse and align substantially close to the stairway in the folded position such that when the access stairway is in the folded position an operator can freely move along the platform

In another aspect, the handrail includes a first elongate member and a second elongate member each has a distal end and a proximal end. The distal end of the first elongate member is rigidly supported on the platform and the distal end of the second elongate member is pivotally connected to the stairway. The handrail further includes a first side member having a first end and a second end. The first end and the second end of the first side member are pivotally connected at the proximal ends of the first and the second elongated member, respectively. The first side member is configured to collapse and align substantially close to the stairway in the folded position.

Other features and aspects of this disclosure will be apparent from the following description and the accompanying drawings.

### BRIEF DESCRIPTION OF THE DRAWINGS

FIG. 1 illustrates a side view of a machine according to an embodiment of the present disclosure;

FIG. 2 illustrates a side view of a powered access ladder in a lowered position according to an embodiment of the present disclosure;

FIG. 3 illustrates a side view of the powered access ladder in a folded position according to an embodiment of the present disclosure; and

FIG. 4 illustrates a rear view of the machine with the powered access ladder in the folded position according to an embodiment of the present disclosure.

### DETAILED DESCRIPTION

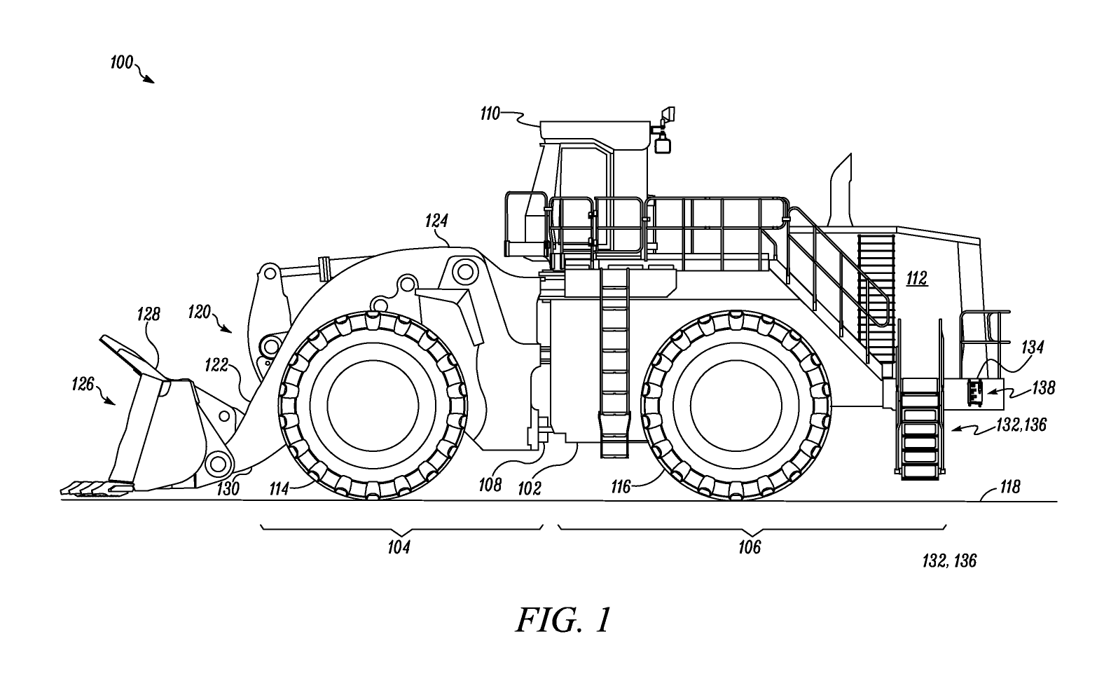

The present disclosure relates to a foldable access stairway adapted for use with a machine. FIG. 1 illustrates a side view of a machine 100, such as a wheel loader, in which various embodiments of the present disclosure may be implemented. In an exemplary embodiment, as illustrated in FIG. 1, the machine 100 may include a frame 102. The frame 102 may include a front section 104 and a rear section 106. In an embodiment, the front section 104 may be connected with the rear section 106 by articulated joints 108. The rear section 106 of the machine 100 may include an operator cab 110 and an engine enclosure 112. As well known in the art, an engine (not shown) may be housed within the engine enclosure 112. The engine is used to provide power to a final drive assembly, via a mechanical or an electrical transmission. The operator cab 110 may include one or more control means to control the operations of the machine 100.

The machine 100 may be supported by ground engaging elements, such as a pair of front wheels 114 (only one side is shown) mounted on the front section 104 and a pair of rear wheels 116 (only one side is shown) mounted on the rear section 106. The front and the rear wheels 114 and 116 may support the machine 100 on a ground 118. In an embodiment, the machine 100 may include a lift arm assembly 120 mounted on the front section 104 of the frame 102. The lift arm assembly 120 may include a lift arm 122 pivotally mounted to the front section 104 at a first end 124. The lift arm assembly 120 may further include an implement 126, such as a bucket 128 pivotally mounted to a second end 130 of the lift arm 122. It will be apparent to a person having ordinary skill in the art that in various other embodiments, the implement 126 may include, but not limited to, a blade, a fork, a grapple, a hammer and the like.

The machine 100 further includes an access stairway 132 to provide an operator or a service technician access to a platform 134. In an embodiment, the access stairway 132 may include a powered access ladder 136 which is maintained at a raised or a folded position during the operation of the machine 100 and at a lowered position to climb onto or get down from the machine 100. In an embodiment, the powered access ladder 136 may include plurality of inbuilt lighting members, but not limited to, LED. In an embodiment, the machine 100 may include a service control panel 138, which is adapted to be positioned on the machine 100 at a location accessible to the operator or the service technician preferably from the platform 134 and the ground 118. The service control panel 138 may provide an interface for a plurality of access and lockout switches to control various operational parameters of the machine 100.

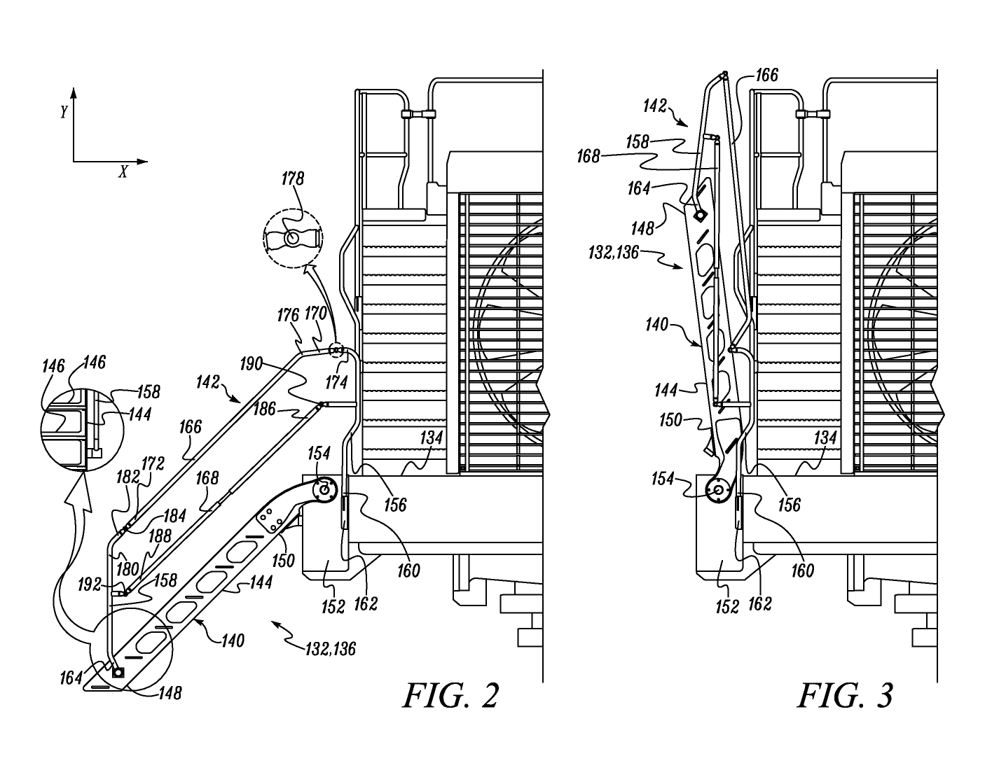

FIGS. 2 and 3 illustrate a side view of the access stairway 132, adapted to provide access onto the platform 134, in the lowered position and the folded position, respectively. Although, the access stairway 132 is embodied as the powered access ladder 136, alternatively the access stairway 132 may include, for example, but not limited to, escalators, ladders, ramps, stair steps, or the like. As illustrated in FIG. 2, the powered access ladder 136 may include a stairway 140, which provides a pathway for the operator to provide access onto the platform 134. Further, the powered access ladder 136 may include a handrail 142 configured to be attached with the stairway 140 to provide a point of contact for the operator, which also provides support and prevents the operator from falling. The powered access ladder 136 may be moved between the lowered position and the folded position either by using the service control panel 138 (see FIG. 1) located on the machine 100 and/or from controls provided in the operator cab 110.

As illustrated in FIGS. 2 and 3, the stairway 140 adapted for in use with the machine 100 may be herein described. The stairway 140 may include a pair of step support portions 144 (only one side is shown). The step support portions 144 may rigidly support a plurality of steps 146 provided in-between and arranged along a length from lower ends 148 to upper ends 150 of the step support portions 144. A pivot deck portion 152 may be provided on the platform 134 and configured to pivotally support the step support portions 144 at the upper ends 150. As illustrated, the pivot deck portion 152 supports the stairway 140 and also allow a pivotal movement about a pivot axis 154, enabling the stairway 140 to move in a plane XY between the lowered position (see FIG. 2) and the folded position (see FIG. 3). The plane XY is substantially perpendicular to the platform 134.

According to an embodiment of the present disclosure, the handrail 142, provided on each side of the stairway 140, may include a first elongate member 156 and a second elongate member 158. The first elongate member 156 may include a flange portion (not shown) provided at a distal end 160, which is rigidly fastened into a bracket 162 provided on the pivot deck portion 152. The second elongate member 158 may be pivotally connected at a distal end 164 with the respective lower ends 148 of the step support portions 144. The handrail 142 further includes a first side member 166 and a second side member 168 which are pivotally supported between the first elongated member 156 and the second elongated member 158 and positioned substantially parallel to each other. The first side member 166 and the second side member 168 may include one or more successive sections of, for example, but not limited to, a round tubular rigid PVC pipe, including having a suitable length and/or shape.

The first side member 166 may include a first end 170 and a second end 172. The first end 170 of the first side member 166 may be pivotally connected at a proximal end 174 of the first elongate member 156, through an elbow 176, by a pivotal joint 178, as illustrated in FIG. 2. Further, the second end 172 of the first side member 166 may be pivotally connected at a proximal end 180 of the second elongate member 158, through an elbow 182, by a pivotal joint 184. Similarly, a first end 186 and a second end 188 of the second side member 168 may be pivotally connected at substantially between the respective distal ends 160, 164 and the proximal ends 174, 180 of the first elongate member 156 and the second elongate member 158 by pivotal joints 190 and 192, respectively.

In an embodiment, the first elongate member 156, the second elongate member 158, the first side member 166 and the second side member 168, of the handrail 142 may have a common inner and outer diameter, and together as assembled and finished, may give the appearance of a smooth one piece, uniform diameter hand railing. Further, the first elongate member 156, the second elongate member 158, the first side member 166 and the second side member 168, of the handrail 142 may be made of, for example, but not limited to, a composite of vinyl applied over a steel or aluminum tubing for added strength. A person ordinarily skilled in the art may understand, additional handrails members of same or varying cross-sections, and of similar or different materials may be adapted for use with the powered access ladder 136 without departing from the scope of the present disclosure.

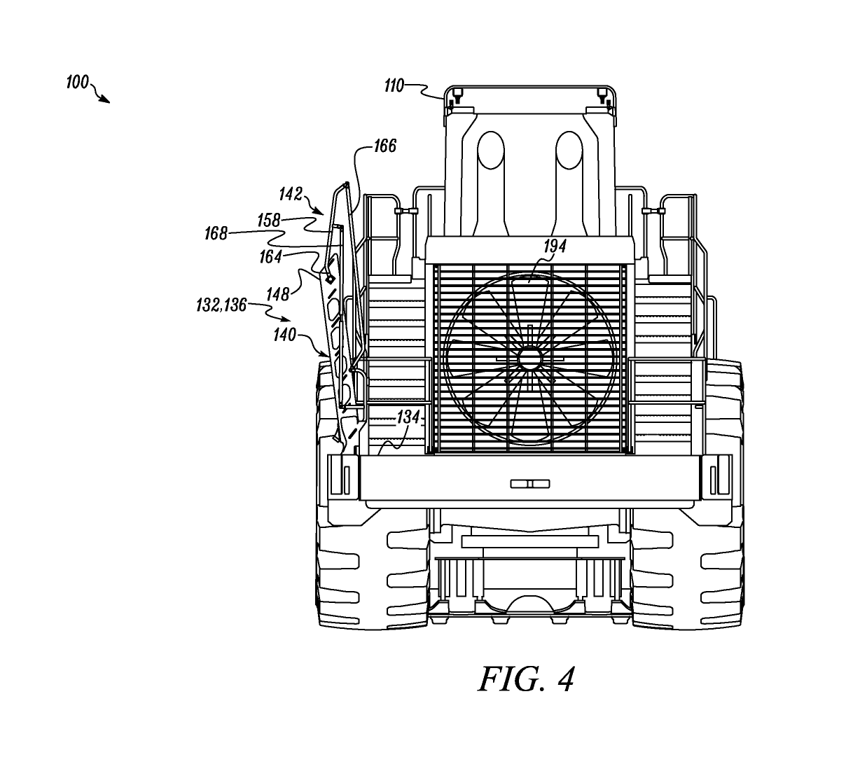

The powered access ladder 136 may be electrically or hydraulically powered. In an embodiment, the powered access ladder 136 may be connected with actuators (not shown), for example one or more hydraulic actuators which may expand and retract in the lowered and the folded positions, respectively. In another embodiment, an electric motor may be coupled with the powered access ladder 136 at the pivot axis 154 configured to move the access stairway case 136 into the lowered and the folded positions. Alternatively, one skilled in the art may understand that various other mechanical means may be adapted for moving the powered access ladder 136 between the lowered and the folded positions. As illustrated in FIG. 4, according to an aspect of the present disclosure, during folding of the powered access ladder 136, the first side member 166 and the second side member 168 of the handrail 142 may collapse and align substantially close to the stairway 140 due to a relative motion at the pivotal joints 178, 184, 190, and 192. Alternatively, the first side member 166 and the second side member 168 of the handrail 142 may include any other type of custom designed joints, for example a linkage mechanism that may fold over in the folded position. Further, the powered access ladder 136 may be locked at different elevations from the ground 118.

### INDUSTRIAL APPLICABILITY

During operation or servicing of the machine 100, the operator may need to mobile from one location to another on the platform 134 for operational or service/maintenance purpose. For example, the operator may need to step down from the operator cab 110 to check the condition of an engine cooling fan 194 located on the rear section 106 of the machine 100, as illustrated in FIG. 4. There should not be any blockage or barriers preventing the access to the engine cooling fan 194 or other components on the platform 134. The blockage or barriers may include, but not limited to, the powered access ladder 136, particularly in the folded position. Therefore, the powered access ladder 136 should be folded in such a way, so that it may not cause obstruction to the operator's access or movement onto the platform 134. Although, the machine 100 is embodied as the wheel loader, the machine 100 may include, but not limited to, an off-highway truck, on-highway truck, a backhoe loader, an industrial loader, a skidder, a wheel tractor, an excavator, a wheel dozer, an articulated truck, a asphalt paver, a cold planer, a compactor, a feller buncher, a forest machine, a forwarder, a harvester, a motor grader, a hydraulic shovel, a road reclaimer, a tele-handler, a mining machine or the like. The machine 100 may be used for lifting and/or handling a load and may be employed in various industries such as, but not limited to, construction and mining.

According to an aspect of the present disclosure, in the folded position of the powered access ladder 138 the handrails 142 substantially aligned close to the stairway 140 and thus avoid any interruption or blockage to the operator's movement on the platform 134. In the embodiment of the present disclosure described above, the pivotal movement of the handrails 142 not only allows easy folding, substantially parallel to the stairway 140, but also, it will apparent from FIG. 4, the platform 134 is not blocked by the handrail 142 and the operator can freely move along the entire platform 134 without having to move the access stairway 132 and/or move the handrail 142 of out a way.

Additionally, the powered access ladder 136 may be locked into the extended or the folded position or in a desired elevation from the ground level 118, so as to provide additional protection to both the operator and machinery. LEDs or the lighting means may be provided on the stairway 140 or the handrail 142 for improved vision during nights or low light climate. In an embodiment, a bias means (not shown) may be provided with the stairway 140 to stay in the extended position.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An access stairway attached with a platform and configured to move in a plane substantially perpendicular to the platform between a lowered position and a folded position, the access stairway comprising:
a stairway configured to be pivotally supported at the platform; and
a handrail attached to the stairway, the handrail is configured to collapse and align substantially close to the stairway, such that when the access stairway is in the folded position an operator can freely move along the platform.

2. The access stairway of claim 1, wherein the handrail includes:
a first elongate member having a distal end and a proximal end, the distal end of the first elongate member is rigidly supported on the platform;
a second elongate member having a distal end and a proximal end, the distal end of the second elongate member is pivotally connected to the stairway; and
a first side member having a first end and a second end, the first end and the second end of the first side member are pivotally connected at the proximal ends of the first and the second elongated member, respectively.

3. The access stairway of claim 2, wherein the first end and the second end of the first side member are pivotally connected at the proximal ends of the first and the second elongate member by pivotal joints.

4. The access stairway of claim 2, wherein the stairway include a pair of step support portions rigidly supporting a plurality of steps provided in-between and arranged along a length from lower ends to upper ends of the step support portions.

5. The access stairway of claim 4, wherein the platform includes a pivot deck portion to pivotally support the step support portions at the upper ends.

6. The access stairway of claim 5, wherein the pivot deck portion includes a bracket to rigidly support the distal end of the first elongated member.

7. The access stairway of claim 2, wherein the handrail further includes a second side member having a first end and a second end, the first end and the second end of the second side member are pivotally connected at substantially between the distal ends and the proximal ends of the first elongate member and the second elongate member, respectively.

8. The access stairway of claim 7, wherein the first end and the second end of the second side member are pivotally connected at substantially between the respective distal ends and the proximal ends of the first elongate member and the second elongate member by pivotal joints.

9. A machine comprising:
a platform; and
an access stairway attached with the platform and configured to move in a plane substantially perpendicular to the platform between a lowered position and a folded position, the access stairway comprising:
a stairway configured to be pivotally supported at the platform; and
a handrail attached to the stairway, the handrail is configured to collapse and align substantially close to the stairway, such that when the access stairway is in the folded position an operator can freely move along the platform.

10. The machine of claim 9, wherein the handrail includes:
a first elongate member having a distal end and a proximal end, the distal end of the first elongate member is rigidly supported on the platform;
a second elongate member having a distal end and a proximal end, the distal end of the second elongate member is pivotally connected to the stairway; and
a first side member having a first end and a second end, the first end and the second end of the first side member are pivotally connected at the proximal ends of the first and the second elongated member, respectively.

11. The machine of claim 10, wherein the first end and the second end of the first side member are pivotally connected at the proximal ends of the first and the second elongate member by pivotal joints.

12. The machine of claim 10, wherein the stairway include a pair of step support portions rigidly supporting a plurality of steps provided in-between and arranged along a length from lower ends to upper ends of the step support portions.

13. The machine of claim 12, wherein the platform includes a pivot deck portion to pivotally support the step support portions at the upper ends.

14. The machine of claim 13, wherein the pivot deck portion includes a bracket to rigidly support the distal end of the first elongated member.

15. The machine of claim 10, wherein the handrail further includes a second side member having a first end and a second end, the first end and the second end of the second side member are pivotally connected at substantially between the distal ends and the proximal ends of the first elongate member and the second elongate member, respectively.

16. The machine of claim 15, wherein the first end and the second end of the second side member are pivotally connected at substantially between the respective distal ends and the proximal ends of the first elongate member and the second elongate member by pivotal joints.

17. An access stairway attached with a platform and configured to move in a plane substantially perpendicular to the platform between a lowered position and a folded position, the access stairway comprising:
a stairway configured to be pivotally supported at the platform; and
a handrail attached to the stairway, the handrail including:
a first elongate member having a distal end and a proximal end, the distal end of the first elongate member is rigidly supported on the platform;
a second elongate member having a distal end and a proximal end, the distal end of the second elongate member is pivotally connected to the stairway; and
a first side member having a first end and a second end, the first end and the second end of the first side member are pivotally connected at the proximal ends of the first and the second elongated member, respectively, and is configured to collapse and align substantially close to the stairway in the folded position an operator can freely move along the platform.

18. The access stairway of claim 17, wherein the first end and the second end of the first side member are pivotally connected at the proximal ends of the first and the second elongate member by pivotal joints.

19. The access stairway of claim 17, wherein the stairway include a pair of step support portions rigidly supporting a plurality of steps provided in-between and arranged along a length from lower ends to upper ends of the step support portions.

20. The access stairway of claim 17, wherein the handrail further includes a second side member having a first end and a second end, the first end and the second end of the second side member are pivotally connected at substantially between the distal ends and the proximal ends of the first elongate member and the second elongate member, respectively, and is configured to collapse and align substantially close to the stairway in the folded position to allow an operator movement onto the platform.
